(19) United States
(12) Patent Application Publication
(10) Pub. No.: US 2026/0081396 A1
(43) Pub. Date: Mar. 19, 2026

(54) ZERO INSERTION FORCE PIN REMOVAL TOOL

(71) Applicant: Schlumberger Technology Corporation, Sugar Land, TX (US)

(72) Inventor: Aman Arab, Pune (IN)

(21) Appl. No.: 18/885,293

(22) Filed: Sep. 13, 2024

(51) Int. Cl. H01R 43/22

(52) U.S. Cl. CPC H01R 43/22

(57) ABSTRACT

A removal tool for removing an electrical conductor from an electrical connector housing includes an insertion pin configured to engage with a retention feature of the electrical conductor to release the electrical conductor from the electrical connector housing. The removal tool further includes a tool insertion tip configured to insert at least partially into the electrical connector housing. The tool insertion tip includes a baseplate; and an insertion pin support.

### BACKGROUND OF THE DISCLOSURE

Electrical connections, from consumer devices to commercial applications, are often made through the use of electrical connectors, sockets, receptacles, etc., for connecting various data and/or power transmission wires. One common form of electrical connection is a zero insertion force (ZIF) connector that is typically used for connecting processors and other integrated circuits to a motherboard without applying excessive force, thereby minimizing the risk of damaging delicate pins within the connector. ZIF connectors may also be implemented as a male or female connector for connecting to another, mating connector.

Electrical connectors such as ZIF connectors facilitate electrical connections by virtue of electrical conductors within the electrical connector, often implemented as pins. ZIF pins, in particular, may typically be blade-style pins that extend from an electrical connector for establishing an electrical connection with another pin, receptacle, solder through hole, etc.

Electrical connectors are typically configured by inserting one or more electrical conductors into various holes, slots, or channels in the electrical connector. The electrical conductors typically have a retention feature such as a detent or lance for locking the electrical conductor in place within the electrical connector, and in order to remove an electrical conductor from the electrical connector, the retention feature must be engaged or released. Electrical conductor removal tools typically have an insertion pin extending from the tool for inserting into the electrical connector to release the retention feature of the electrical conductor. The insertion pins of these removal tools are prone to failure due to repeated use, improper alignment, and poor mechanical properties, among other reasons. Thus, an improved removal tool that can facilitate electrical conductor removal without failing may be advantageous.

### SUMMARY

In some embodiments, a removal tool for removing an electrical conductor from an electrical connector housing includes an insertion pin configured to engage with a retention feature of the electrical conductor to release the electrical conductor from the electrical connector housing. The removal tool includes a tool insertion tip configured to insert at least partially into the electrical connector housing. The tool insertion tip includes a baseplate and an insertion pin support.

In some embodiments, a removal tool for removing an electrical conductor from an electrical connector housing includes a tool body, a tool insertion tip connected to the tool body, and an insertion pin positioned within the tool body and configured to pass through the tool insertion tip.

In some embodiments, a method of using a removal tool for removing an electrical conductor from an electrical connector housing includes inserting a baseplate of a tool insertion tip of the removal tool at least partially into a conductor channel of the electrical connector housing in which the electrical conductor is positioned. The method includes sliding an insertion pin from an insertion pin support of the removal tool. The method further includes, based on sliding the insertion pin, engaging a retention feature of the electrical conductor with the insertion pin to release the electrical conductor from the electrical connector housing.

This summary is provided to introduce a selection of concepts that are further described in the detailed description. This summary is not intended to identify key or essential features of the claimed subject matter, nor is it intended to be used as an aid in limiting the scope of the claimed subject matter. Additional features and aspects of embodiments of the disclosure will be set forth herein, and in part will be obvious from the description, or may be learned by the practice of such embodiments.

### BRIEF DESCRIPTION OF THE DRAWINGS

In order to describe the manner in which the above-recited and other features of the disclosure can be obtained, a more particular description will be rendered by reference to specific embodiments thereof which are illustrated in the appended drawings. For better understanding, the like elements have been designated by like reference numbers throughout the various accompanying figures. While some of the drawings may be schematic or exaggerated representations of concepts, at least some of the drawings may be drawn to scale. Understanding that the drawings depict some example embodiments, the embodiments will be described and explained with additional specificity and detail through the use of the accompanying drawings in which:

FIG. 1-1 is a perspective view of an electrical connector, according to at least one embodiment of the present disclosure;

FIG. 1-2 is a perspective view of a conventional removal tool in connection with an electrical connector, according to at least one embodiment of the present disclosure;

FIG. 2-1 is a side view, FIG. 2-2 is a top view, and FIG. 2-3 is a perspective view of a removal tool 200 for removing electrical conductors from electrical connectors, according to at least one embodiment of the present disclosure;

FIGS. 3-1 and 3-2 illustrate side views of a removal tool, according to at least one embodiment of the present disclosure;

FIGS. 4-1, 4-2 and 4-3 are side views, and FIG. 4-4 is a front view of a removal tool 420 implemented in connection with an electrical conductor, according to at least one embodiment of the present disclosure;

FIGS. 5-1 and 5-2 are perspective views of a removal tool being implemented in connection with an electrical connector, according to at least one embodiment of the present disclosure;

FIG. 6 is a top schematic view of a removal tool 620 implemented in connection with an electrical connector, according to at least one embodiment of the present disclosure; and

FIG. 7 is a flow diagram for a method or a series of acts for using a removal tool for removing an electrical conductor from an electrical connector housing as described herein, according to at least one embodiment of the present disclosure.

### DETAILED DESCRIPTION

This disclosure generally relates to a removal tool for removing electrical conductors from an electrical connector. For example, electrical conductors, such as ZIF pins, may be positioned within a conductor channel of an electrical connector, and may be retained in the conductor channel by a retention feature such as a retention lance. By engaging and/or deflecting the retention feature, the electrical conductor can be released from securement in the conductor channel and removed from the electrical connector.

The removal tool of the present disclosure includes a tool insertion tip. The tool insertion tip includes a baseplate and an insertion pin support for engaging the electrical conductor and facilitating the removal thereof. The baseplate is a thin member that extends from the tool insertion tip and is configured to insert into the conductor channel between the electrical conductor and a base of the conductor channel. The baseplate may facilitate a proper alignment of the removal tool with the conductor channel. The baseplate extends from the insertion pin support and similarly facilitates a property lighten of the insertion pin support with the conductor channel.

The insertion pin support can be a hollow or open structure. For example, an insertion pin of the removal tool may be positioned at least partially within the insertion pin support and/or may be configured to slide through the insertion pin support. The insertion pin support may contact the inserting pin to maintain a position of, and provide support to, the insertion pin. For example, in some cases the insertion pin support may be triangular in shape. The insertion pin support may facilitate a proper alignment of the insertion pin with the electrical conductor and conductor channel, as well as prevent damage to the insertion pin by providing strength and support to the insertion pin.

The insertion pin support may be configured such that the electrical conductor (e.g., tip of the electrical conductor) inserts at least partially into the insertion pin support. For example, the electrical conductor may insert into the insertion pin support at or near a base of the insertion pin support, and between the base and the insertion pin (or a path of the insertion pin). In this way, the insertion pin may be positioned and configured to slide past or over a main body of the electrical conductor in order to engage and/or deflect the retention feature of the electrical conductor. The electrical conductor and the insertion pin both being positioned within the insertion pin support may facilitate a proper alignment of the insertion pin with respect to the electrical conductor and conductor channel in order to prevent damage to the electrical conductor and/or insertion pin. In this way, the removal tool may be implemented to facilitate the release and removal of electrical conductors from the electrical connector. For instance, the removal tool may facilitate a proper alignment of the insertion pin such that the removal tool may be used repeatedly and at length with a reduced risk of failure of the insertion pin. Additionally, the insertion pin may be made of a hardened material, such as a hardened steel or tool steel, such that the insertion pin may withstand repeated, and even improper use, without failing.

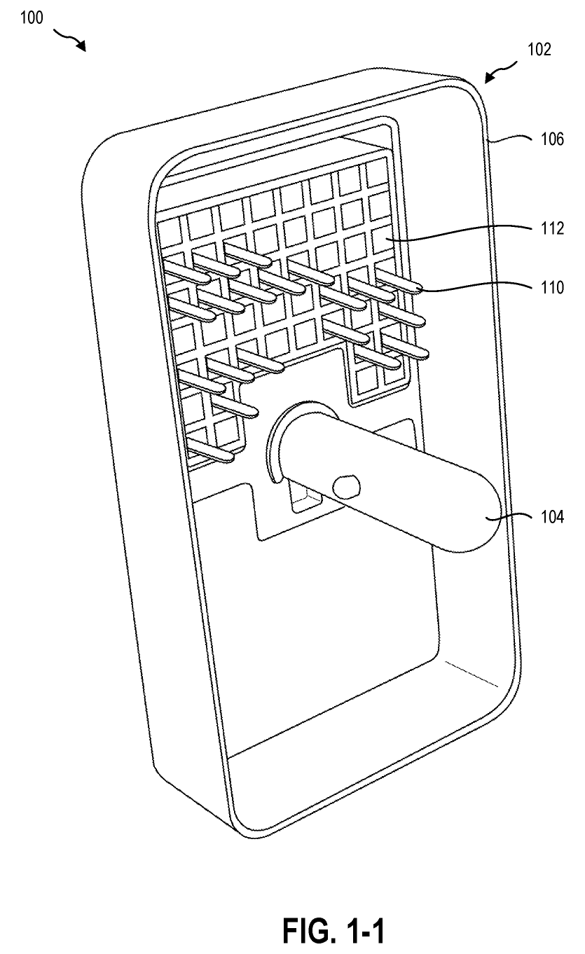

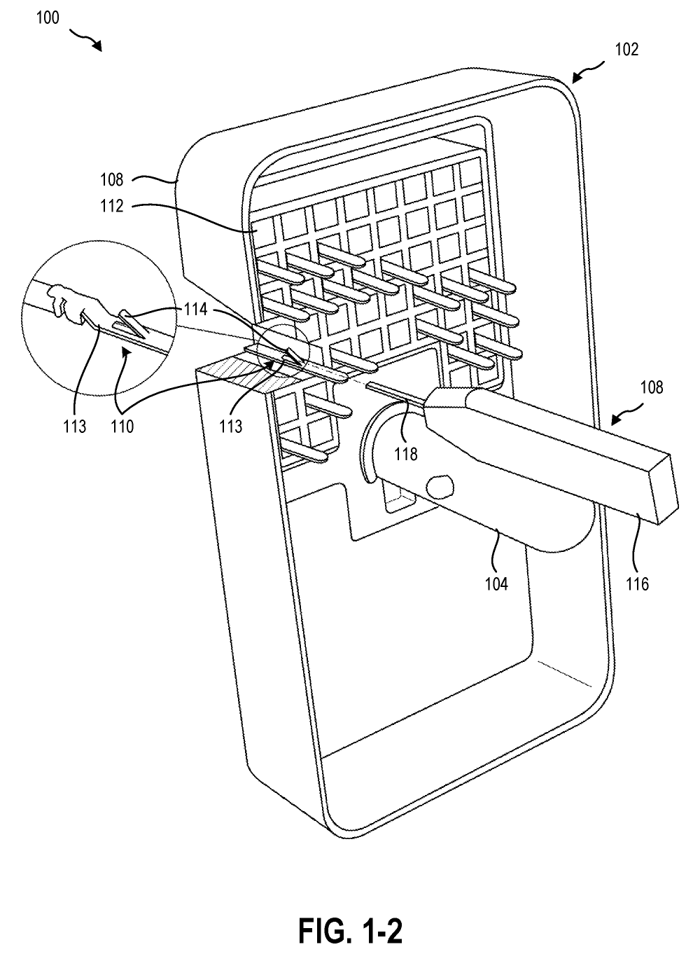

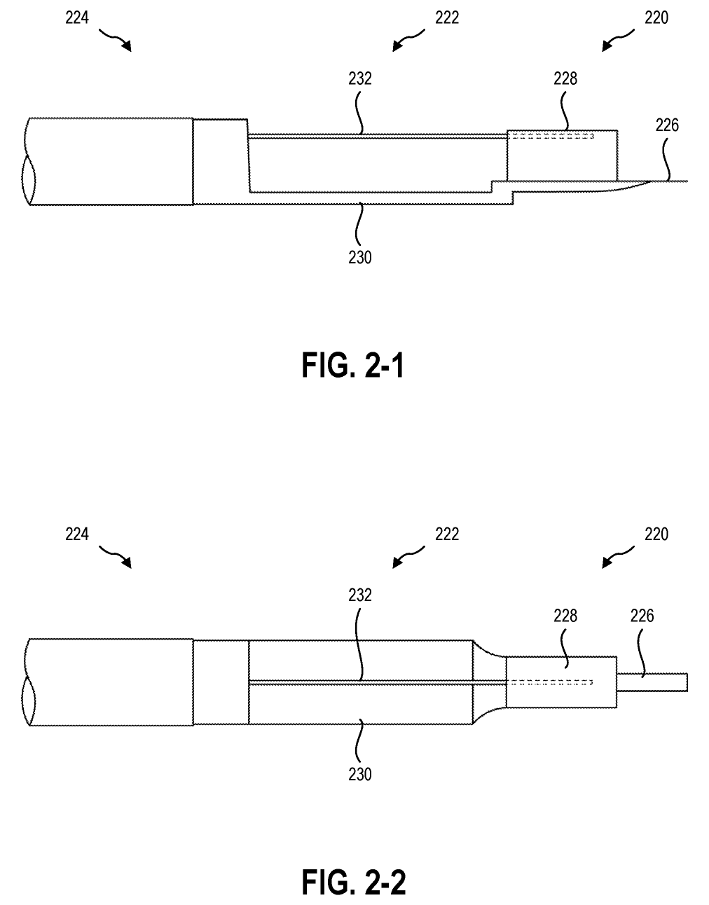

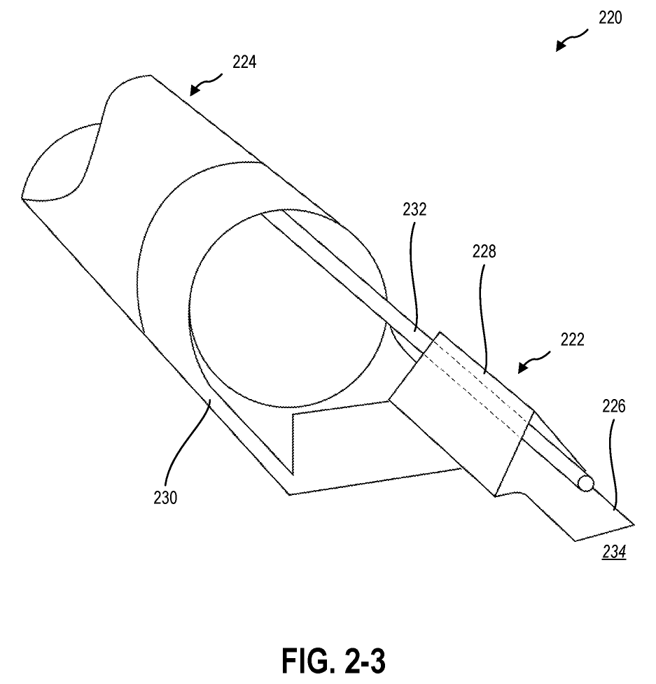

Additional details will now be provided regarding systems described herein in relation to illustrative figures portraying example implementations. For example, FIG. 1-1 shows one example of an electrical connector 100. The same electrical connector 100 is shown in FIG. 1-2, with respect to a conventional removal tool 108 for removing electrical conductors from the electrical connector 100. The electrical connector 100 may be any type of electrical receptable or connector for facilitating the connection of one or more electrical wires or cables. In one particular example, the electrical connector 100 may be a ZIF connector for facilitating making an electrical connection with a reduced force. Such may facilitate ease of use, reduced risk of damage to components of the electrical connector 100, etc.

The electrical connector 100 may include a connector housing 102. The connector housing 102 may define a shape or form of the electrical connector 100. For instance, the connector housing 102 may have a particular geometry, shape, or other form factor, for facilitating the electrical connector 100 connecting to a mating component, such as a motherboard or another electrical connector. In some cases, the connector housing 102 may include an alignment feature 104, an outer rim 106, and/or other structures or features for instance, for aligning, securing, or otherwise establishing a connection of the electrical connector 100 with another component.

The electrical connector 100 houses one or more electrical conductors 110. The electrical conductors 110 may be any electrically conductive component for facilitating and establishing an electrical connection of one or more wires or cables of the electrical connector 100 with another electrical conductor. For instance, the electrical conductors 110 may be pin conductors, post conductors, male conductors, female conductors, or any other type of conductors. In some cases, the electrical conductors 110 are electrical pins. For instance, the electrical conductors 110 may be ZIF pins. The electrical conductors 110 may be round, flat, square, arcuate, hollow, solid, or may have any other shape or form factor. In some embodiments, the electrical conductors 110 are blade-style pins, such as flat-shaped conductors.

The connector housing 102 includes one or more conductor channels 112. The conductor channels 112 may be grooves, slots, recesses, holes, tunnels, channels, or any other structure or feature for housing and/or securing one or more of the electrical conductors 110. For instance, the conductor channels 112 may be through-holes that pass through some or all of the connector housing 102. The electrical conductors 110 may be positioned in the conductor channels 112. For instance, the electrical conductors 110 may be inserted into (e.g., from a front side or a back side of the connector housing 102) the conductor channels 112 and may be retained within the conductor channels 112.

In some embodiments, the electrical conductors 110 are positioned substantially within the conductor channels 112. For instance, a conductor tip 113 of the electrical conductors 110 may be positioned within the conductor channels 112 and/or may not extend from the conductor channels 112. For instance, the electrical conductor 110 and conductor channel 112 configured in this way may form a female portion or receptable of the electrical connector 100. In some embodiments, the electrical conductors 110 extend at least somewhat from the connector housing 102 and/or conductor channels 112. For example, the conductor tip 113 may extend from the conductor channels 112. For instance, the electrical conductor 110 and conductor channel 112 configured in this way may form a male portion or receptable of the electrical connector 100.

As shown in FIG. 1-2, the electrical conductors 110 may include a retention feature 114. For instance, the retention feature 114 may be a tab, detent, lance, or any other suitable structure for retaining the electrical conductors 110 in the conductor channels 112. The retention feature 114 may engage with a mating feature within the conductor channels 112, such as by snapping or locking at a mating recess, detent, or other mating feature. In this way, the electrical conductors 110 may be positioned, maintained, and/or locked in place within the connector housing 102.

In some embodiments, to remove an electrical conductor 110 from the connector housing 102, the retention feature 114 may be depressed, deflected, or otherwise engaged in order to release the electrical conductor 110, after which the electrical conductor 110 may be removed or slid out of a corresponding conductor channel 112 (e.g., through a front or a back side of the connector housing 102).

FIG. 1-2 shows a conventional removal tool 108 for releasing the electrical conductors 110. The conventional removal tool 108 may typically include a tool body 116 such as a handle, and an insertion pin 118 connected to and extending from the tool body 116. The insertion pin 118 may have an elongate shape and may be configured to insert, at least somewhat, into the connector housing 102, and in some cases into the conductor channels 112, in order to engage the retention feature 114 and release the electrical conductor 110. For instance, the insertion pin may insert into the conductor channel 112 and may slide on top of or above (e.g., with respect to the orientation of the illustrative FIG. 1-2) the electrical conductor 110 to engage the retention feature 114. In other embodiments or configurations of the connector housing 102 and/or the electrical conductor 110, the insertion pin 118 and conventional removal tool 108 may be otherwise configured to accommodate alternate designs of conductor channels, electrical conductors, retention features, etc.

In many cases, the conventional removal tool 108 may be prone to failure. For instance, the insertion pin 118 may tend to bend, break, break off from the tool body 116, or exhibit other modes of failure. For instance, the insertion pin 118 being inserted into the conductor channel 112 at a misaligned angle with the conductor channel 112 and/or the electrical conductor 110 may cause the conventional removal tool 108 to experience one or more forces or torques that may cause the insertion pin 118 (or other part of the conventional removal tool 108) to bend, break, or otherwise fail. For instance, forces or torques on the insertion pin 118 (e.g., on a distal end of the insertion pin 118) may be transmitted through the insertion pin 118 and to the tool body 116, causing forces and/or torques of an increased degree at a connection between the insertion pin 118 and the tool body 116. As such, the insertion pin 118 may tend to break at the connection or another location. For instance, the insertion pin 118 may typically be made of mild steel that, over time and after repeated and/or improper use, may wear, flex, become degraded, break, and/or otherwise fail. As shown, the conventional removal tool 108 may typically not be configured with features for ensuring proper alignment of the insertion pin 118 with respect to the connector housing 102. Additionally, the conventional removal tool 108 may typically not be configured with features for supporting and/or maintaining the mechanical integrity of the insertion pin 118 such that the insertion pin 118 cannot withstand repeated and/or improper use.

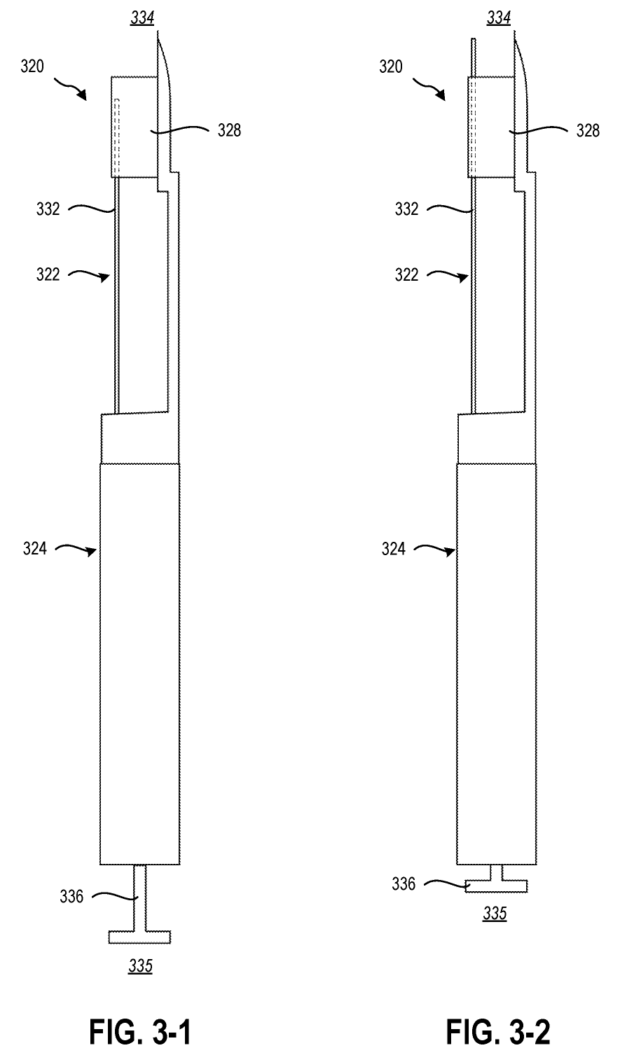

FIG. 2-1 is a side view, FIG. 2-2 is a top view, and FIG. 2-3 is a perspective view of a removal tool 220 for removing electrical conductors from electrical connectors as described herein, according to at least one embodiment of the present disclosure. The removal tool 220 may provide improvements and benefits over that of conventional removal tools.

The removal tool 220 includes a tool insertion tip 222. The tool insertion tip 222 may be connected to a tool body 224. For example, the tool body 224 may be a handle for gripping and manipulating the tool insertion tip 222. The tool body 224 may be a tool body of, for example, an automated system for positioning and implementing the tool insertion tip 222. For example, the tool body 224 may be part of a robotic arm or other automated device for automatically utilizing the removal tool 220. In some embodiments, multiple insertion tips 222 may be connected to a tool body, for example, for implementing in connection with an electrical connector having multiple electrical conductors and for removing several electrical conductors in conjunction.

The tool insertion tip 222 includes a baseplate 226 and an insertion pin support 228. The baseplate 226 and insertion pin support 228 are connected to a link 230 for joining the tool insertion tip 222 to the tool body 224. The link 230 may be rigid and may securely support the baseplate 226 and the insertion pin support 228. For example, any forces and/or torques exerted on the baseplate 226 and/or the insertion pin support 228 may be effectively transferred to the tool body 224 through the link 230. The link 230 may be a substantially open structure as shown. For example, the link 230 may be a structure that spans a lower side of the removal tool 220. In some cases, the link 230 may include one or more closed and/or hollow structures for enclosing some or all of the baseplate 226, the insertion pin support 228, the tool body 224, or any other component (e.g., such as an insertion pin). Indeed, the link 230 may be any suitable structure for securely and rigidly connecting the baseplate 226 and insertion pin support 228 to the tool body 224.

In some embodiments, the baseplate 226 extends from the link 230 toward a distal end 234 of the removal tool 220. For example, the baseplate 226 may be a substantially flat or planar member that extends toward the distal end 234. The baseplate 226 may have a rectangular or square shape. As described herein, the baseplate 226 may be configured to insert into a conductor channel of an electrical connector in order to align the removal tool 220 with an electrical conductor positioned within the conductor channel as described herein. The baseplate 226 may take any other form or shape suitable for performing this functionality.

The baseplate 226 may be substantially flat and thin. For example, the baseplate 226 may have a thickness that is no greater than 2 mm, 1 mm, 0.5 mm, 0.4 mm, 0.3 mm, 0.2 mm, or 0.1 mm. The thickness of the baseplate 226 in this way may facilitate the baseplate inserting into a conductor channel, and in some cases, between a base of the conductor channel and an electrical conductor as described herein. **[AMAN: CAN YOU PLEASE CONFIRM THIS THICKNESS, AS WELL AS PROVIDE THE LENGTH AND WIDTH THAT THE BASEPLATE WILL TYPICALLY BE?]**

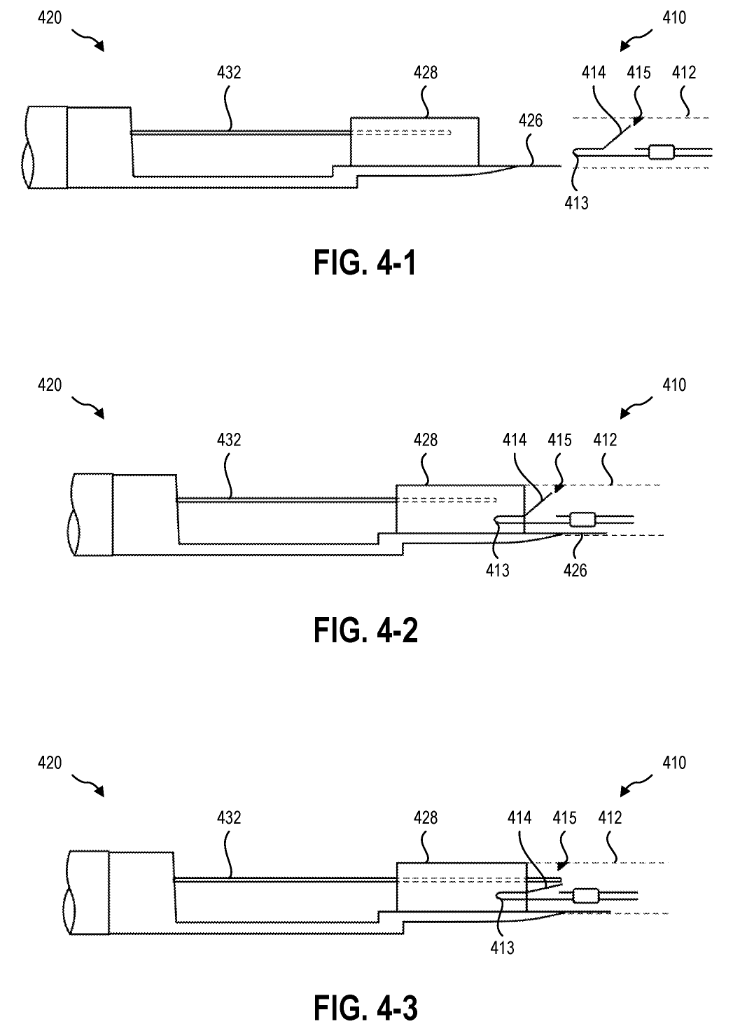

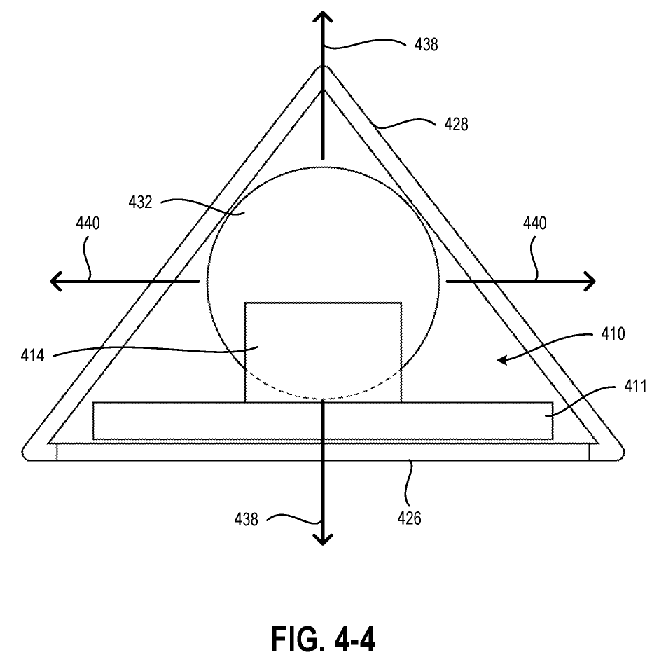

The insertion pin support 228 may be positioned above or on top of the baseplate 226. For example, the baseplate 226 may at least partially be a base of the insertion pin support 228. In some examples, at least some of the baseplate 226 extends outward past the insertion pin support 228. The insertion pin support 228 may be a hollow structure. For example, the insertion pin support 228 may be triangular in shape, and may have a hollow interior, such as that shown and described in connection with FIG. 4-4.

The removal tool 220 includes an insertion pin 232. The insertion pin 232 may be positioned at least partially within the insertion pin support 228. The insertion pin 232 may be contained at least partially within the tool body 224 and may be configured to slide into and/or out of the tool body 224. For instance, as described herein, the insertion pin 232 may be configured to slide, longitudinally with respect to the removal tool 220, through the insertion pin support 228. The insertion pin 232 may slide toward the distal end 234 and may extend at least somewhat from and/or past the insertion pin support 228. As described herein, the insertion pin support 228 may provide support to the insertion pin 232 in upward and/or lateral directions, for example, to reduce forces and/or torques exerted on and/or transferred through the insertion pin 232. The insertion pin support 228 may also facilitate fixing and/or aligning a vertical and/or lateral position of the insertion pin with respect to a conductor channel and/or an electrical conductor as described herein.

In some embodiments, the insertion pin 232 is made of a hardened material. For example, the insertion pin 232 may be made of a hardened steel, such as tool steel. The insertion pin 232 being hardened in this way may facilitate the insertion pin 232 being inserted into an electrical connector (e.g., repeatedly) without becoming worn, bent, broken, or otherwise failing. The insertion pin 232 may be made of other materials such as metals, plastics, or composites.

FIGS. 3-1 and 3-2 illustrate side views of a removal tool 320, according to at least one embodiment of the present disclosure. The removal tool 320 may be substantially similar to and/or may include any of the features of the removal tools described herein in connection with other illustrative figures.

The removal tool 320 may include a tool body 324 and a tool insertion tip 322. The tool body 324 may include an actuator 336. The actuator 336 may be operatively coupled to an insertion pin 332 and may facilitate extending, advancing, sliding, or otherwise positioning the insertion pin 332. For example, the actuator 336 may be a plunger that is connected to the insertion pin 332. Actuating or pressing the plunger may advance the insertion pin 332 through and out of an insertion pin support 328 of the removal tool 320. In some embodiments, the removal tool 32 may include a biasing element which may engage the insertion pin 332 and/or the actuator 336 (e.g., plunger) for biasing or returning or retracting the insertion pin 332 to an initial position. For example, the biasing element may be a spring. The biasing element may be positioned within, on, or around the tool body 324. The biasing element may bias the insertion pin 332 toward a distal end 334 or toward a proximal end 335 of the removal tool 320. In this way, the actuator may facilitate extending the insertion pin 332, for example, such that the insertion pin 332 may extend into an electrical connector and engage a retention feature of an electrical conductor to release the electrical conductor from the electrical connector as described herein.

The actuator 336 may be any type of actuator and may be positioned and/or configured at any location of the removal tool 320. For example, the actuator 336 may include a button, a slide, a linkage, lever, tab, strap or another element for engaging with and causing the actuator to operate. In some embodiments, the actuator may be an electric actuator, a hydraulic actuator, or a pneumatic actuator for positioning the insertion pin 332. In some embodiments, the actuator may include a bistable mechanism such that the insertion pin may be positioned in two, bistable positions, for example, such as extended and retracted. The actuator may be any type of actuation and/or extension device for positioning the insertion pin 332 and may include any means of actuation. For instance, in some examples, the removal tool 320 and/or actuator may be wholly or partly automated, such that the removal tool may be positioned, implemented, and/or actuated with little or no human intervention.

FIGS. 4-1, 4-2 and 4-3 are side views and FIG. 4-4 is a front view of a removal tool 420 implemented in connection with an electrical conductor 410, according to at least one embodiment of the present disclosure. The removal tool 420 may be substantially similar to and/or may include any of the features of the removal tools described herein in connection with other illustrative figures.

The electrical conductor 410 may be implemented in an electrical connector. For simplicity, only a conductor channel 412 of the electrical connector is shown. The electrical conductor includes a retention feature 414. The retention feature 414 may be a tab, detent, or lance (or another retention feature) that may extend from the electrical conductor 410 and may engage a mating feature 415 of an electrical connector in order to position and secure the electrical conductor within the electrical connector. As described herein, the electrical conductor 410 may be positioned partly or wholly within the conductor channel 412.

The removal tool 420 may be utilized by positioning the removal tool 420 with respect to the electrical conductor 410. As shown in FIG. 4-2, the removal tool 420 may be inserted toward the electrical conductor 410 and/or the conductor channel 412. A portion of the removal tool 420 may be inserted into an electrical connector and/or connector housing as described herein. For instance, a baseplate 426 of the removal tool 420 may insert into and/or be positioned within the conductor channel 412. The baseplate 426 may be positioned between the electrical conductor 410 and the conductor channel 412. For instance, the baseplate 426 may be positioned underneath the electrical conductor 410 between a bottom or base of the electrical conductor 410 and a base of the conductor channel 412. The baseplate 426 may insert entirely or partially into the conductor channel 412.

The baseplate 426 being positioned in this way may facilitate aligning the removal tool 420 with respect to the conductor channel 412 and/or the electrical conductor 410. For example, the baseplate 426 may have a length and/or width that facilitates aligning the removal tool 420. For instance, the baseplate 426 may have a width that is substantially the same as a width of the conductor channel 412. The baseplate 426 may have a length that is long enough that it may insert into the conductor channel 412 and may be positioned beneath the electrical conductor 410 and such that the baseplate 426 may only be inserted into the conductor channel 412 in this way in a substantially aligned, parallel, or colinear orientation with the conductor channel 412. For instance, the length and/or width of the baseplate 426 may prevent the baseplate from being inserted at a transverse or misaligned angle with the conductor channel 412. In this way, the baseplate may facilitate a proper alignment of the removal tool with the conductor channel 412 and electrical conductor 410.

As shown in FIG. 4-2, the removal tool 420 may be positioned and configured such that the electrical conductor 410 may insert and/or may be positioned at least partially within an insertion pin support 428 of the removal tool 420. For instance, a conductor tip 413 of the electrical conductor 410 may be positioned within the insertion pin support 428. The electrical conductor 410 may be positioned within the insertion pin support 428 between the baseplate 426 and an insertion pin 432 of the removal tool. For example, as shown in FIG. 4-4 the insertion pin support 428 may be triangular shaped, and the insertion pin 432 may be positioned near a top corner of the insertion pin support 428. The electrical conductor 410 may insert into the insertion pin support 428 below the insertion pin 432 (e.g., physically below the insertion pin 432 and/or below a slidable path of the insertion pin 432) at or near a base of the insertion pin support 428, such as at or near the baseplate 426.

The electrical conductor 410 inserting into the insertion pin support 428 in this way may facilitate properly aligning the removal tool 420 with the electrical conductor 410 and/or the conductor channel 412. For example, the insertion pin support 428 may be sized, shaped, and/or configured such that the electrical conductor 410 may fit snugly within the insertion pin support 428, for example, with or without the insertion pin 432 also being physically positioned within the inserting pin support. For instance, a base or bottom of the (e.g., triangular shape of the) insertion pin support 428 may be shaped and configured such that the electrical conductor 410 may insert into the insertion pin support 428 in an aligned, parallel, and/or colinear orientation. For instance, the electrical conductor 410 may not insert into the insertion pin support 428 in a transverse or otherwise misaligned orientation. In this way, the insertion pin support 428 may facilitate a proper alignment of the removal tool 420 with the conductor channel 412 and/or the electrical conductor 410, for instance, in addition to or independent of the alignment functionality of the baseplate 426.

The insertion pin support 428 being triangular shaped in this way may be an illustrative example of how the insertion pin support 428 may be configured. The insertion pin support 428 may be shaped or formed in any other configuration that is suitable and/or provides the functionalities described herein. For example, the insertion pin support 428 may have a portion that is shaped complimentary to the insertion pin 432 (e.g., round, flat, square, rectangular, etc.) in order to position and support the insertion pin, and may include a portion that is shaped complimentary to the electrical conductor 410 to facilitate proper alignment. The insertion pin support 428 may be any shape or combination of shapes, such as a non-uniform or non-normal shape.

The insertion pin support 428 may be shaped and configured in this way in order to facilitate properly positioning the insertion pin 432. For example, the insertion pin 432 being positioned in the upper corner of the (e.g., triangular shaped) insertion pin support 428 may fix and/or secure a vertical 438 and/or lateral 440 position of the insertion pin 432. For instance, a force or torque applied (e.g., in any direction) to the insertion pin may not cause the insertion pin to move vertically 438 and/or laterally 440 based on the insertion pin support 428 maintaining the position of the insertion pin 432. Additionally, the electrical conductor 410 being positioned beneath or below the insertion pin 432 may maintain a lower vertical position of the inserting pin against the electrical conductor 410 and/or the baseplate 426. In this way, the insertion pin support 428 may facilitate the insertion pin 432 being properly aligned with respect to the conductor channel 412 and the electrical conductor 410.

Additionally, the insertion pin support 428 supporting and maintaining the position of the insertion pin 432 in this way may provide support and strength to the insertion pin 432. For example, any force and/or torque applied to the insertion pin may not be transferred through the insertion pin to the tool body, which may cause stress, bending, breaking, and/or failure of the insertion pin 432, but rather, the torque and/or force may be transferred to the insertion pin support 428. In this way, the strength and integrity of the insertion pin 432 may be maintained in order to prevent failure of the insertion pin 432 and to promote repeated use of the insertion pin 432. The insertion pin support 428 may even prevent damage to the insertion pin 432 from misuse and/or misaligned use transferring forces and/or torques to the insertion pin 432.

The electrical conductor 410 may be positioned within the insertion pin support 428 such that a body 411 of the electrical conductor 410 is not positioned within a longitudinal or slidable path of the insertion pin 432. However, the retention feature 414 may be positioned in the slidable path of the insertion pin 432. For instance, a lance, tab, or other member of the retention feature 414 may extend from the body 411 upward and/or into a space in which the insertion pin 432 may occupy when extended and/or actuated. As shown in FIG. 4-3, the insertion pin 432 may extend and/or actuate forward and may engage the retention feature 414. This engagement may cause the retention feature 414 to release from the mating feature 415 and/or otherwise from an engagement with the conductor channel 412. For instance, the insertion pin 432 may bend or deflect the retention feature 414 out of the way of the mating feature 415 such that the retention feature may no longer catch or retain on the mating feature 415. The insertion pin 432 may have a tip or distal end that is shaped to facilitate engagement and/or release of the retention feature 414. For example, the tip of the insertion pin 432 may be pointed, conical, round, flat, bladed, ridged, or otherwise configured to facilitate engagement with the retention feature 414. Additionally, the insertion pin 432 may be any suitable shape and/or may have any suitable cross section. For example, the insertion pin 432 may be round (e.g., cylindrical), flat, triangular, rectangular, square, or any other shape. The insertion pin 432 may have a non-uniform shape, such as having several different cross-sectional shapes with transitions from one type of cross-section to another. In this way, the insertion pin 432 may engage the retention feature 414 and may release the electrical conductor from securement in the conductor channel 412.

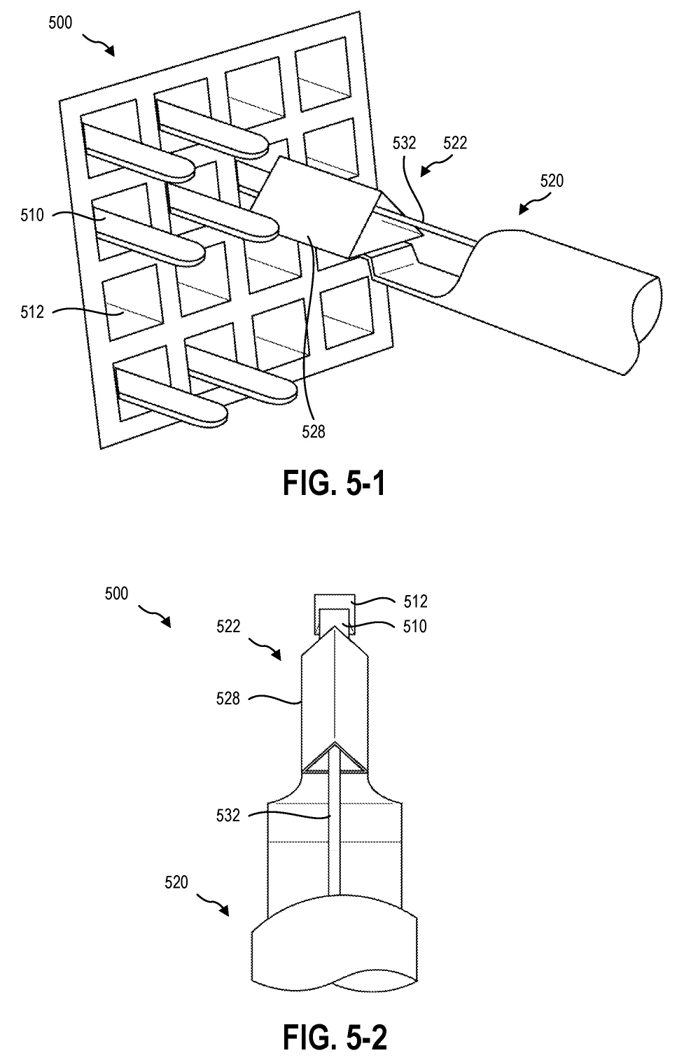

FIGS. 5-1 and 5-2 are perspective views of a removal tool 520 being implemented in connection with an electrical connector 500, according to at least one embodiment of the present disclosure. The removal tool 520 may be substantially similar to and/or may include any of the features of the removal tools described herein in connection with other illustrative figures.

The removal tool 520 may be implemented to release one or more electrical conductors 510 from the electrical connector 500. For example, the removal tool 520 may include a tool insertion tip 522 having features for interacting with and/or engaging with the electrical connector 500. As described herein, the tool insertion tip 522 may include a baseplate that may insert into a conductor channel 512 of the electrical connector 500. An electrical conductor 510 may be positioned within the conductor channel 512 and, in some cases, may extend somewhat from the conductor channel 512. The electrical conductor 510 may insert partly into an insertion pin support 528 of the tool insertion tip 522. In some embodiments, the insertion pin support 528 may insert at least somewhat into the conductor channel 512. For example, in cases where the electrical conductor 510 does not extend from the conductor channel 512, the insertion pin support 528 may be sized and configured to insert into the conductor channel 512, and the electrical conductor 510 may insert into the insertion pin support 528 inside of the conductor channel 512.

The removal tool 520 may include an insertion pin 532. The insertion pin 532 may extend and/or actuate from the insertion pin support 528 in order to engage and/or release a retention feature of the electrical conductor 510. In some cases, the insertion pin 532 may extend into the conductor channel 512. The baseplate and/or the insertion pin support may facilitate the removal tool 520 being properly aligned with the conductor channel 512 and/ electrical conductor 510 such that the electrical conductor 510 and/or the removal tool does not become worn or damaged.

In this way, the removal tool 520 may be implemented to facilitate the removal of one or more electrical conductors 510 from the electrical connector 500. The removal tool 520 may be sized and configured to be utilized in connection with any size, type, form, or variation of electrical conductor and/or electrical connector. For example, in some cases, the removal tool 520 is configured for use with ZIF pins and ZIF connectors. In other cases, the removal tool 520 may be configured for use with any other type of electrical connector having any number, orientation, size, and configuration of electrical conductors.

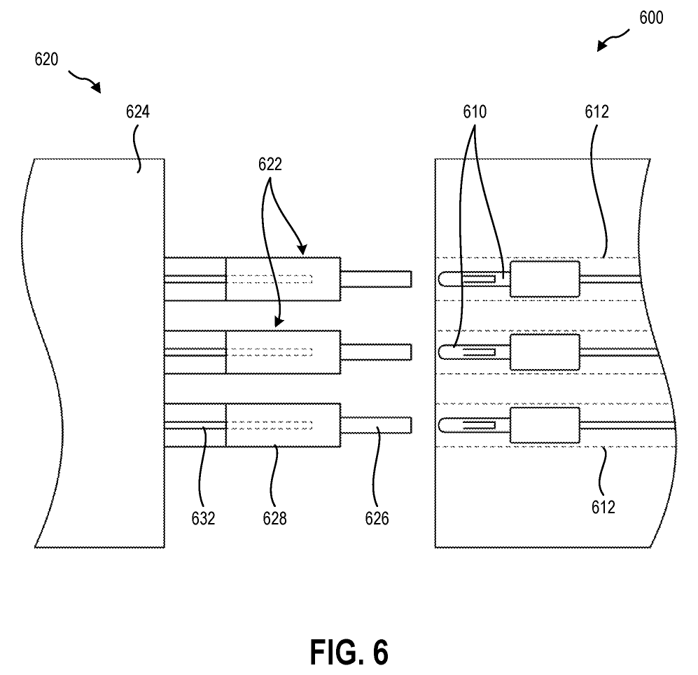

FIG. 6 is a top schematic view of a removal tool 620 implemented in connection with an electrical connector 600, according to at least one embodiment of the present disclosure. The removal tool 620 may include any of the features of the removal tools described herein in connection with other illustrative figures.

In some embodiments, the removal tool 620 includes several tool insertion tips 622. For example, each tool insertion tip 622 may include a baseplate 626 and an insertion pin support 628. The removal tool 620 may include an insertion pin 632 associated with each tool insertion tip 622. The removal tool 620 having multiple tool insertion tips 622 may be configured for engaging with and releasing multiple electrical conductors, for example, simultaneously. For example, the tool insertion tips 622 may be connected to a (e.g., same) tool body 624 and may be positioned and configured in a complementary manner to multiple conductor channels 612 of the electrical connector 600. For instance, the electrical connector 600 may include multiple conductor channels 612 arranged in a line, grid, array, or other pattern or configuration. Similarly, the removal tool 620 may include multiple tool insertion tips 622 arranged (e.g., via connection to the tool body 624) in a line, grid, array, or other pattern to engage multiple conductor channels 612 and electrical conductors 610 as arranged in the electrical connector 600. In some embodiments, the removal tool 620 may include tool insertion tips 622 for engaging some of the conductor channels 612 of the electrical connector 600. In some embodiments, the removal tool 620 may include tool insertion tips 622 for engaging all of the conductor channels 612 of the electrical connector 600. Each of the insertion pins 632 may be configured to actuate at once, or at different times, to release the electrical conductors 610 as described herein.

In this way, the removal tool 620 may be configured with multiple tool insertion tips 622 for facilitating the removal of several electrical conductors 610 from the electrical connector 600. For example, the removal tool 620 may be a universal-type removal tool 620 for removing entire or part(s) of lines, grids, or other sections of electrical conductors from the electrical connector 600. In some cases, the removal tool 620 may be specifically designed for a particular electrical connector or type of electrical connector, for example, to mate with the electrical connector and facilitate ease of removal of the electrical conductors from the electrical connector.

In this way the various removal tools described herein may be implemented to release and/or facilitate removal of electrical conductors from electrical connectors. In some embodiments, the removal tools may be implemented as manual or hand tools for manually manipulating and utilizing in connection with removing electrical conductors. In some embodiments, the removal tools may be implemented as part of a semi- or fully automated system, for example, for automatically releasing and/or removing electrical conductors from electrical connectors. For example, the removal tool may be manually positioned, and may be automatically actuated to release one or more electrical conductors. In another example, the removal tools may be included in a system for automatically positioning and (e.g., automatically or manually) actuating the insertion pin(s). For example, one or more robotic arms may be implemented for positioning the removal tool with respect to the electrical conductor.

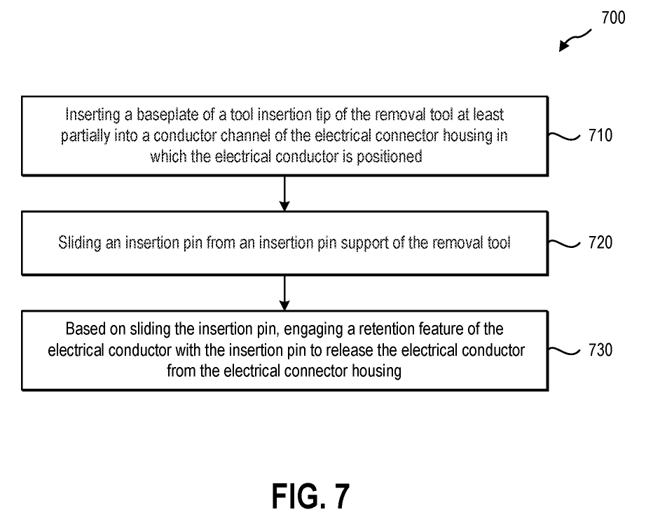

FIG. 7 illustrates a flow diagram for a method 700 or a series of acts for using a removal tool for removing an electrical conductor from an electrical connector housing as described herein, according to at least one embodiment of the present disclosure. While FIG. 7 illustrates acts according to one embodiment, alternative embodiments may add to, omit, reorder, or modify any of the acts of FIG. 7.

In some embodiments, the method 700 includes an act 710 of inserting a baseplate of a tool insertion tip of the removal tool at least partially into a conductor channel of the electrical connector housing in which the electrical conductor is positioned. For example, the baseplate may be positioned between a base of the electrical conductor and a base of the conductor channel. In some embodiments, the method includes inserting the electrical conductor at least partially within the insertion pin support.

In some embodiments, the method 700 includes an act 720 of sliding an insertion pin from an insertion pin support of the removal tool.

In some embodiments, the method 700 includes an act 730 of, based on sliding the insertion pin, engaging a retention feature of the electrical conductor with the insertion pin to release the electrical conductor from the electrical connector housing. For example, engaging the retention feature may include deflecting the retention feature with the insertion pin. In some embodiments, the method 700 includes removing the electrical conductor from the electrical connector housing.

### INDUSTRIAL APPLICABILITY

One or more specific embodiments of the present disclosure are described herein. These described embodiments are examples of the presently disclosed techniques. Additionally, in an effort to provide a concise description of these embodiments, not all features of an actual embodiment may be described in the specification. It should be appreciated that in the development of any such actual implementation, as in any engineering or design project, numerous embodiment-specific decisions will be made to achieve the developers’ specific goals, such as compliance with system-related and business-related constraints, which may vary from one embodiment to another. Moreover, it should be appreciated that such a development effort might be complex and time consuming, but would nevertheless be a routine undertaking of design, fabrication, and manufacture for those of ordinary skill having the benefit of this disclosure.

Additionally, it should be understood that references to “one embodiment” or “an embodiment” of the present disclosure are not intended to be interpreted as excluding the existence of additional embodiments that also incorporate the recited features. For example, any element described in relation to an embodiment herein may be combinable with any element of any other embodiment described herein. Numbers, percentages, ratios, or other values stated herein are intended to include that value, and also other values that are “about” or “approximately” the stated value, as would be appreciated by one of ordinary skill in the art encompassed by embodiments of the present disclosure. A stated value should therefore be interpreted broadly enough to encompass values that are at least close enough to the stated value to perform a desired function or achieve a desired result. The stated values include at least the variation to be expected in a suitable manufacturing or production process, and may include values that are within 5%, within 1%, within 0.1%, or within 0.01% of a stated value.

A person having ordinary skill in the art should realize in view of the present disclosure that equivalent constructions do not depart from the spirit and scope of the present disclosure, and that various changes, substitutions, and alterations may be made to embodiments disclosed herein without departing from the spirit and scope of the present disclosure. Equivalent constructions, including functional “means-plus-function” clauses are intended to cover the structures described herein as performing the recited function, including both structural equivalents that operate in the same manner, and equivalent structures that provide the same function. It is the express intention of the applicant not to invoke means-plus-function or other functional claiming for any claim except for those in which the words ‘means for’ appear together with an associated function. Each addition, deletion, and modification to the embodiments that falls within the meaning and scope of the claims is to be embraced by the claims.

The terms “approximately,” “about,” and “substantially” as used herein represent an amount close to the stated amount that is within standard manufacturing or process tolerances, or which still performs a desired function or achieves a desired result. For example, the terms “approximately,” “about,” and “substantially” may refer to an amount that is within less than 5% of, within less than 1% of, within less than 0.1% of, and within less than 0.01% of a stated amount. Further, it should be understood that any directions or reference frames in the preceding description are merely relative directions or movements. For example, any references to “up” and “down” or “above” or “below” are merely descriptive of the relative position or movement of the related elements. Additionally, as used herein, the term “and/or” includes any and all combinations of one or more of the associated listed items.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A removal tool for removing an electrical conductor from an electrical connector housing, comprising:
an insertion pin configured to engage with a retention feature of the electrical conductor to release the electrical conductor from the electrical connector housing; and
a tool insertion tip configured to insert at least partially into the electrical connector housing, the tool insertion tip including;
a baseplate; and
an insertion pin support.

2. The tool of claim 1, wherein the insertion pin is positioned at least partially within the insertion pin maintain a vertical and lateral position of the insertion pin.

3. The tool of claim 1, wherein the baseplate extends from a base of the insertion pin support and is configured to insert into a conductor channel of the electrical connector housing in which the electrical conductor is positioned.

4. The tool of claim 3, wherein the baseplate is configured to insert between a base of the electrical conductor and a base of the conductor channel.

5. The tool of claim 1, wherein the insertion pin is positioned to extend at least partially into a conductor channel of the electrical connector and is slidable to engage a retention feature of the electrical conductor to deflect the retention feature and release the electrical conductor.

6. The tool of claim 1, wherein the insertion pin support is configured such that the electrical conductor inserts at least partially into the insertion pin support.

7. The tool of claim 6, wherein the electrical conductor inserts into the insertion pin support between the baseplate and a slidable path of the insertion pin.

8. The tool of claim 1, wherein the insertion pin is made of a hardened material.

9. The tool of claim 1, wherein the insertion pin support has a triangular shape.

10. The tool of claim 1, wherein the electrical connector housing is a zero insertion force (ZIF) connector and the electrical conductor is a ZIF pin.

11. A removal tool for removing an electrical conductor from an electrical connector housing, comprising:
a tool body;
a tool insertion tip connected to the tool body; and
an insertion pin positioned within the tool body and configured to pass through the tool insertion tip.

12. The tool of claim 11, wherein the tool body includes a handle for manipulating the removal tool.

13. The tool of claim 11, further comprising an actuator for sliding the insertion pin.

14. The tool of claim 11, wherein the tool insertion tip is a first tool insertion tip and the insertion pin is a first insertion pin, and wherein the removal tool further includes a second tool insertion tip connected to the tool body and a second insertion pin positioned within the tool body and configured to pass through the second tool insertion tip.

15. The tool of claim 14, wherein the first tool insertion tip and the first insertion pin are positioned and configured to engage with the electrical conductor to release the electrical conductor from the electrical connector housing, and wherein the second tool insertion tip and the second insertion pin are positioned and configured to engage with a second electrical conductor to release the second electrical conductor from the electrical connector housing.

16. A method of using a removal tool for removing an electrical conductor from an electrical connector housing, the method comprising:
inserting a baseplate of a tool insertion tip of the removal tool at least partially into a conductor channel of the electrical connector housing in which the electrical conductor is positioned;
sliding an insertion pin from an insertion pin support of the removal tool; and
based on sliding the insertion pin, engaging a retention feature of the electrical conductor with the insertion pin to release the electrical conductor from the electrical connector housing.

17. The method of claim 16, further comprising removing the electrical conductor from the electrical connector housing.

18. The method of claim 16, further comprising inserting the electrical conductor at least partially within the insertion pin support.

19. The method of claim 16, wherein engaging the retention feature includes deflecting the retention feature with the insertion pin.

20. The method of claim 16, wherein inserting the baseplate includes positioning the baseplate between a base of the electrical conductor and a base of the conductor channel.
